(19) United States
(12) Patent Application Publication
(10) Pub. No.: US 2025/0335156 A1
(43) Pub. Date: Oct. 30, 2025

(54) MEMORY SYSTEM AND METHODS FOR ACCELERATING RECURRENT NEURAL NETWORKS

(71) Applicant: TAIWAN SEMICONDUCTOR MANUFACTURING COMPANY, LTD., Hsinchu (TW)

(72) Inventors: Xiaoyu SUN, San Jose, CA (US); Murat Kerem AKARVARDAR, Hsinchu City (TW)

(73) Assignee: TAIWAN SEMICONDUCTOR MANUFACTURING COMPANY, LTD., Hsinchu (TW)

(21) Appl. No.: 18/648,170

(22) Filed: Apr. 26, 2024

(51) Int. Cl. G06F 7/544; G06F 7/50; G06F 7/53

(52) U.S. Cl. CPC G06F 7/5443; G06F 7/50; G06F 7/5318

(57) ABSTRACT

A memory device is provided. The memory device comprises a multiply-and-accumulate (MAC) circuit and a post processing circuit. The MAC circuit comprises vector engine circuits that store a first input vector of a current time step of a recurrent neural network (RNN) and a first hidden vector of a previous time step of the RNN. The vector engine circuits perform MAC operations of the first input vector, the first hidden vector and a weight matrix. The post processing circuit generates a second hidden vector of the current time step of the RNN according to results of the MAC operations.

### BACKGROUND

Recurrent neural network (RNN) is commonly used for applications involving sequence processing, for example, language translation, DNA sequence analysis, sentiment classification, etc. Due to the sequential processing across time steps of RNN, reduction of the number of reloading weights and inputs and the control complexity is a challenge for designing RNN compute-in-memory (CIM) or near-memory-compute (NMC) device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a memory device 10 in accordance with some embodiments of the present disclosure.

FIG. 2 is a schematic diagram of a long short-term memory (LSTM) RNN, in accordance with some embodiments of the present disclosure.

FIG. 3A is a schematic diagram of a dataflow to the multiply-and-accumulate (MAC) circuit of the memory device shown in FIG. 1, in accordance with some embodiments of the present disclosure.

FIG. 3B is a schematic diagram of an example of data storage of the MAC circuit shown in FIG. 3A, in accordance with some embodiments of the present disclosure.

FIG. 4A is a schematic diagram of an example of dataflow to the MAC circuit corresponding to the dataflow shown in FIG. 3A, in accordance with some embodiments of the present disclosure.

FIG. 4B is a schematic diagram of an example of dataflow to the MAC circuit corresponding to the dataflow shown in FIG. 4A, in accordance with some embodiments of the present disclosure.

FIG. 4C is a schematic diagram of an example of dataflow to the MAC circuit corresponding to the dataflow shown in FIG. 4B, in accordance with some embodiments of the present disclosure.

FIG. 5 is a flowchart diagram of a method for operating the memory device 10 as shown in FIG. 1, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

This application relates to near-memory-compute (NMC) implementing neural network computations. The neural networks, consisting of interconnected processing nodes, computing predictions according to input data and weights of the processing nodes. These computations rely on dot-product and absolute difference computations, typically performed by multiply-accumulate (MAC) operations. Large neural networks face challenges due to the impracticality of storing vast data in processor caches, leading to data transfer bottlenecks. NMC circuits conduct operations locally near memory, reducing data movement between memory and the processor, enhancing throughput, and minimizing energy consumption.

In some embodiments, this application implements a recurrent neural network (RNN). A RNN includes a chain-like structure with repeating RNN cells corresponding to different time steps. Each RNN cell generates a hidden vector as an output of the current time step according to an input vector and a hidden vector of the previous time step. Such structure is suitable for processing sequence of data. Therefore, RNNs are commonly applied to application involving sequence, like speech recognition, analysis of DNA sequences, language modeling, translation, image captioning, and more.

Take translation application for example, a RNN takes a sentence (sequence of words) of a first language as input and generates a sentence of a second language as output. Specifically, in a time step, an input of a RNN cell is a word (encoded as a vector) in the sentence of the first language. An output (hidden vector) of the RNN cell is a translated word of the second language. The RNN cell generates the output (translated word) of the current time step according to the input and an previously translated word. Generating translated words in his manner helps implementing semantics analysis of the sentence.

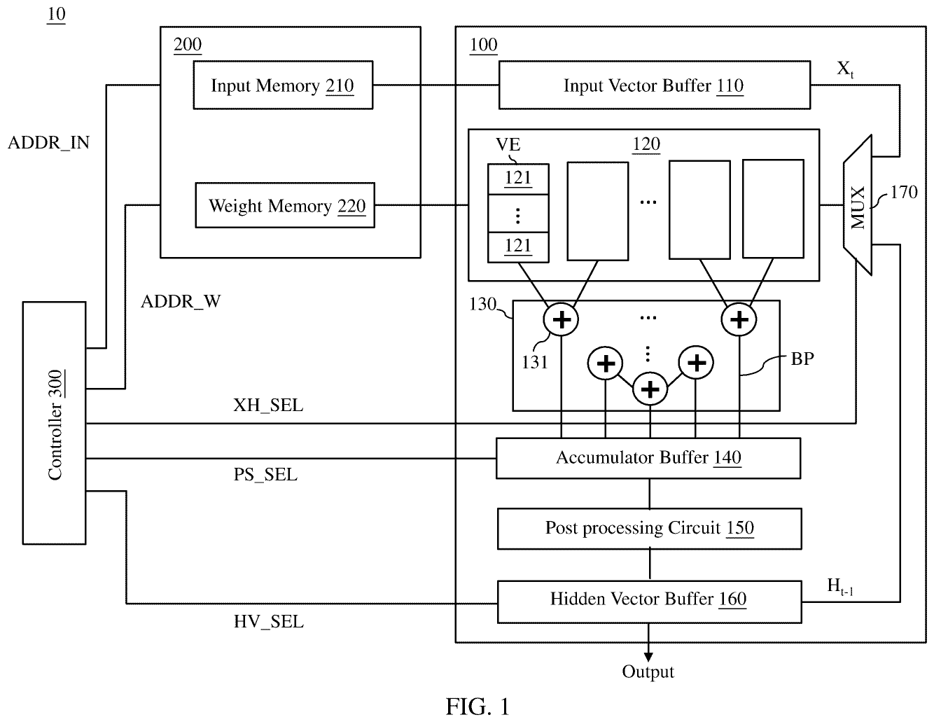

According to some embodiments, a computing unit (e.g., MAC unit) of the near-memory-compute core circuit of this application is based on a compute-in-memory (CIM) cell. Different from some approaches, the dataflow to the computing units of this application is in an input-stationary manner instead of a weight-stationary manner. Specifically, the computing units of this application store input vectors and performs computations (e.g., MAC operations) to the stored input vectors and weights of the RNN streamed to the computing units. Unlike the weight-stationary approaches that may suffer from repeating writing different weights to the computing units and fetching a same input vector for multiple times in a single time step, the input-stationary manner of this application reduces control complexity and improves energy efficiency with weights and an input vector accessed only once in a time step. Reference is now made to FIG. 1. FIG. 1 is a schematic diagram of a memory device 10 in accordance with some embodiments of the present disclosure. In some embodiments, the memory device 10 is configured as a NMC device for neural network. For illustration, the memory device 10 includes a circuit 100, a memory 200 and a controller 300.

In some embodiments, the circuit 100 is configured as a NMC core circuit. In some embodiments, the circuit 100 is configured as a NMC core circuit of the memory 200 for processing RNN computations. For example, the memory 200 store weights of a RNN and input data to the RNN; and the circuit 100 performs computations of the RNN according to the weights and input data fetched from the memory 200. In some embodiments, the circuit 100 generates outputs including hidden vectors of the RNN.

As shown in FIG. 1, the circuit 100 includes an input vector buffer 110, a multiply-and-accumulate (MAC) circuit 120, an adder tree 130, an accumulator buffer 140, a post processing circuit 150, a hidden vector buffer 160 and a multiplexer (MUX) 170. The input vector buffer 110 is coupled to a first input terminal of the MUX 170. The MAC circuit 120 is coupled to an output terminal of the MUX 170 and the adder tree 130. The adder tree 130 is further coupled to the accumulator buffer 140. The accumulator buffer 140 is further coupled to the post processing circuit 150. The post processing circuit 150 is further coupled to the hidden vector buffer 160. The hidden vector buffer 160 is coupled to a second input terminal of the MUX 170. In some embodiments, the hidden vector buffer 160 generates the output including hidden vectors of all time steps of the RNN.

The MAC circuit 120 includes one or more vector engine circuits VE. Each vector engine circuit VE includes one or more MAC units 121. In some embodiments, the MAC units 121 of a vector engine circuit VE are coupled in series.

The adder tree 130 includes one or more adders 131. In some embodiments, each vector engine circuit VE is coupled to an adder 131. In some embodiments, every two vector engine circuits VE are coupled to a same adder 131. In some embodiments, each of the adders 131 are coupled to the accumulator buffer 140 through bypass paths BP. In some embodiments, instead of each of the adders 131 coupled to the accumulator buffer 140, only portions of the adders 131 that generate results of dot product operations are coupled to the accumulator buffer 140, in which a result of a dot operation indicates a sum of results of the MAC operations of an input/hidden vector and a vector of the weights. According to some embodiments, the memory 200 is a global buffer or memory like static random-access memory (SRAM), resistive random access memory (RRAM), magneto-resistive random access memory (MRAM), dynamic random-access memory (DRAM), any suitable memory, or combination thereof. The memory 200 includes input memory 210 and weight memory 220. In some embodiments, the input memory 210 is a first portion, of the memory 200, configured to store input data for computations of a neural network. The weight memory 220 is a second portion, of the memory, configured to store weights of the neural network. In some embodiments, the input memory 210 is coupled to the input vector buffer 110 and the weight memory 220 is coupled to the MAC circuit 120.

The controller 300 may be a central processing unit (CPU), or other general-purpose or special-purpose processor, a microprocessor, a digital signal processor (DSP), a programmable controller, an application-specific integrated circuit (ASIC), an arithmetic logic unit (ALU), a complex programmable logic device (CPLD), a field-programmable gate array (FPGA), or other similar components or a combination of the above components. The controller 300 is coupled to the circuit 100 and the memory 200. In some embodiments, the controller 300 is coupled to the accumulator 140, the hidden vector buffer 160 and the MUX 170. The controller 300 control the circuit 100 and the memory 200 through signals, for example, signals ADDR_IN, ADDR_W, XH_SEL, PS_SEL and HV_SEL.

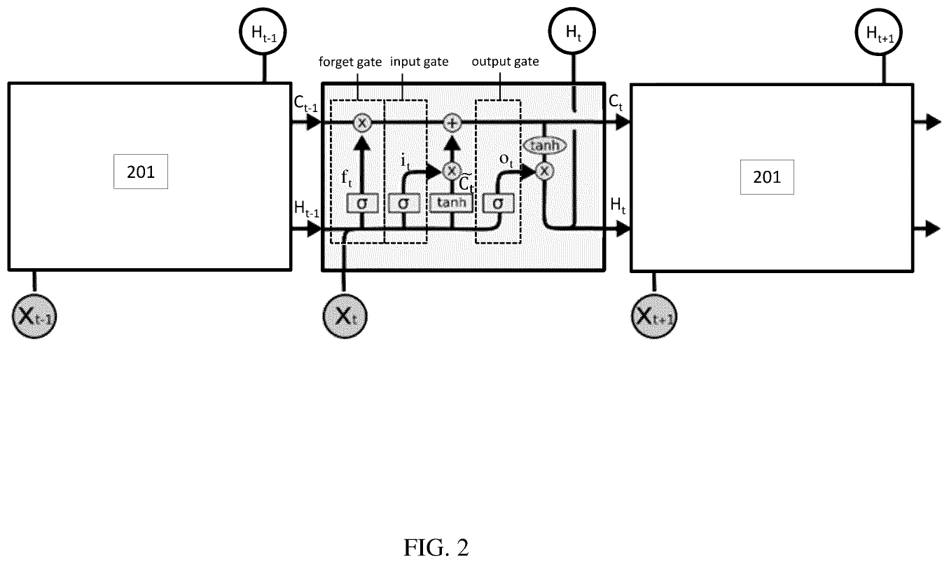

Reference is now made to FIG. 2. FIG. 2 is a schematic diagram depicting an operation of a long short-term memory (LSTM) RNN corresponding to the RNN of FIG. 1, in accordance with some embodiments of the present disclosure.

In some embodiments, the circuit 100 processes operations of a LSTM RNN as shown in FIG. 2. For illustration, a LSTM RNN includes LSTM cell 201. In order to keep track of arbitrary long-term dependencies in the sequence of input vectors X, a LSTM cell 201 generates predictions of the current time step t according to predictions of the previous time step t−1. For example, as shown in FIG. 2, at the time step t, the LSTM cell 201 predicts hidden vector Hₜ according to the input vector Xₜ of the time step t and the hidden vector Hₜ₋₁ and a cell state Cₜ₋₁ that are predicted at the previous time step t−1.

As shown in FIG. 2, a LSTM cell 201 includes a forget gate, an input gate and an output gate. In a time step t, the LSTM cell 201 generate a hidden vector hₜ according to a parameter [symbol] and the parameters fₜ, iₜ and oₜ that are generated through the forget gate, the input gate and the output gate respectively. Equations of the parameters fₜ, iₜ, [symbol] and oₜ are shown as the followings.

$${f}_{t} = σ ( Wf \cdot [ {H}_{t - 1} , {X}_{t} ] + bf ) ; \\ {i}_{t} = σ ( Wi \cdot [ {H}_{t - 1} , {X}_{t} ] + bi ) ; \\ = tanh ( Wc \cdot [ {H}_{t - 1} , {X}_{t} ] + bc ) ; \\ {o}_{t} = σ ( Wo \cdot [ {H}_{t - 1} , {X}_{t} ] + bo )$$

In the above equations, σ corresponds to an activation function (e.g., sigmoid); and hₜ₋₁ corresponds to a hidden vector generated at a previous time step t−1; Xₜcorresponds to an input vector at the time step t. The matrix (gate matrix) Wf and bias bf correspond to forget gate weights and bias of the LSTM RNN; the matrix Wi and bias bi correspond to input gate weights and bias of the LSTM RNN; the matrix Wc and bias bc correspond to weights and bias for cell state of the LSTM RNN; and the matrix Wo and bias bo correspond to output gate weights and bias of the LSTM RNN.

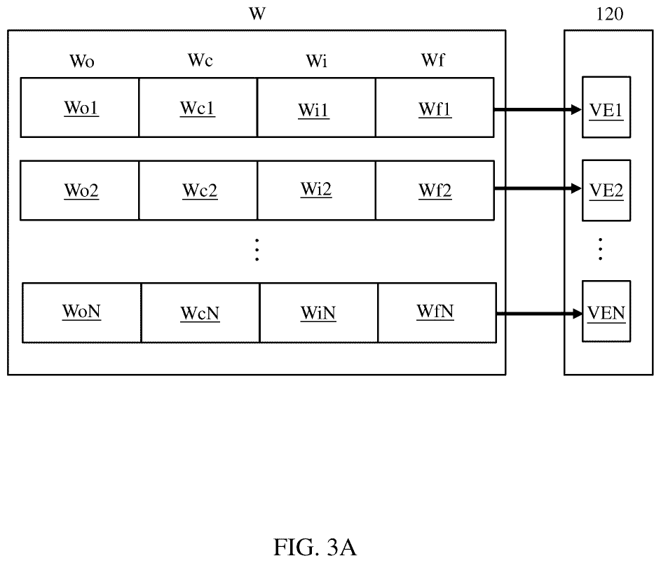

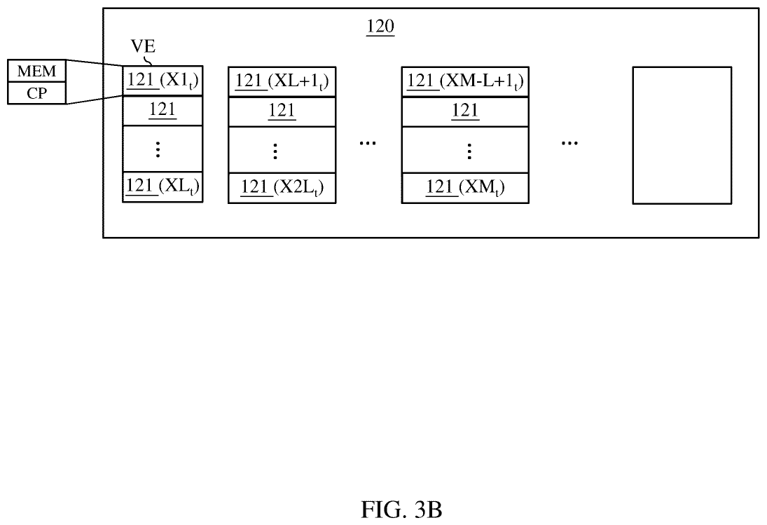

Reference is now made to FIGS. 1-2 and 3A. FIG. 3A is a schematic diagram of a dataflow to the MAC circuit 120 of the memory device 10 shown in FIG. 1, in accordance with some embodiments of the present disclosure.

According to the embodiments in which the circuit 100 performs computations of a RNN, the MAC circuit 120 operates with an input stationary dataflow. Specifically, the vector engine circuits VE store input vectors (input data) from the input vector buffer 110 and hidden vectors of the RNN; and the weights (weight matrix W) of the RNN from the weight memory 220 are streamed to the vector engine circuits VE sequentially to perform MAC operations of the input vectors, the hidden vectors and the weights. The weight matrix W is a concatenation of all weights of the RNN.

In some embodiment in which the RNN is a LSTM RNN, the weight matrix W shown in FIG. 3A includes the concatenated matrices (sub-matrices) Wo, Wc, Wi and Wf. The concatenated matrices Wo, Wc, Wi and Wf are streamed to the MAC circuit 120 to perform MAC operations with input vectors and hidden vectors stored in the vector engine circuits VE. For example, in some embodiments, the matrices Wo, Wc, Wi and Wf are streamed to the MAC circuit 120 to generate dot product results Wo·[Hₜ₋₁, xₜ], Wc·[Hₜ₋₁, xₜ], Wi[19 Hₜ₋₁, xₜ], and Wf·[Hₜ₋₁, xₜ].

In some embodiments, the concatenated matrices (e.g., Wo, Wc, Wi and Wf) are streamed to the MAC circuit 120 sequentially. Specifically, vectors (columns or rows) of the concatenated matrices are streamed to the MAC circuit 120 without reloading (i.e., same elements of the same weight vector will not be repeatedly streamed to same MAC units 121 in one RNN time step).

In some embodiments, different portions of the matrices in the weight matrix W are streamed to corresponding vector engine circuits VE. For example, as shown in FIG. 3A, different portions of the matrices Wo, Wc, Wi and Wf are streamed to the vector engine circuits VE1-VEN that are configured with respect to the vector engine circuit VE. Specifically, first portions Wo1, Wc1, Wi1, Wf1 corresponding to the matrices Wo, Wc, Wi, Wf respectively are streamed to the vector engine circuit VE1; second portions Wo2, Wc2, Wi2, Wf2 corresponding to the matrices Wo, Wc, Wi, Wf respectively are streamed to the vector engine circuit VE2. . . . Nth portions WoN, WcN, WiN, WfN corresponding to the matrices Wo, Wc, Wi, Wf respectively are streamed to the vector engine circuit VEN.

Reference is now made to FIGS. 1-2 and 3A-3B. FIG. 3B is a schematic diagram of an example of data storage of the MAC circuit 120 shown in FIG. 3A, in accordance with some embodiments of the present disclosure.

In some embodiments, the MAC unit 121 in the vector engine circuit VE is a compute-in-memory (CIM) cell. In some embodiments, the MAC unit 121 includes a memory cell MEM and a computing circuit CP. In application, the memory cell MEM of the MAC unit 121 includes one or more bit cells for storing an element of an input vector. For example, at a time step t, an input vector Xₜ which is a binary vector is inputted to the MAC circuit 120; and the memory cell MEM of the MAC unit 121 is used to store an element (a bit of binary one or zero) of the input vector Xₜ.

According to some embodiments, the computing circuit CP performs computations to the data stored in the memory cell MEM and data streamed to the MAC unit 121. In some embodiments, the computing circuits CP of a vector engine circuit VE perform an element-wise multiply operation to the data stored in the memory cells MEM of the vector engine circuit VE and data streamed to the computing circuits CP. For example, when a first column of the weight W is streamed to the MAC circuit 120, an element of the first column of the weight W is streamed to a computing circuit CP of a corresponding MAC unit 121; the computing circuit CP performs a multiplication operation to the element of the first column of the weight W and the data stored in the memory cell MEM; and the computing circuits CP in a same vector engine circuit VE cooperatively perform accumulation operation to the multiplication results generated by the computing circuits CP to sum of the multiplication results. In some embodiments, the computing circuit CP includes suitable multiplier circuit, adder circuit, accumulator circuit, or the combinations thereof to perform MAC operation. In some embodiments, the computing circuits CP in a vector engine circuit VE are integrated into one computing circuit.

In some embodiments, the length of an input vector is greater than the length of a vector engine circuit VE. For example, in the embodiment shown in FIG. 3B, the length of a input vector Xₜ is M (including elements X1ₜ-XMₜ), the length of a vector engine circuit VE is L (including L MAC units 121), M and L being positive integers. When M is greater than L, the input vector Xₜ is divided into ceil (e.g., M/L) parts and stored in ceil (M/L) vector engine circuits VE separately, in which the ceil indicates the ceiling function. In such embodiments, the weight corresponding to the input vector Xₜis divided into ceil (M/L) parts and streamed to the corresponding vector engine circuits VE separately.

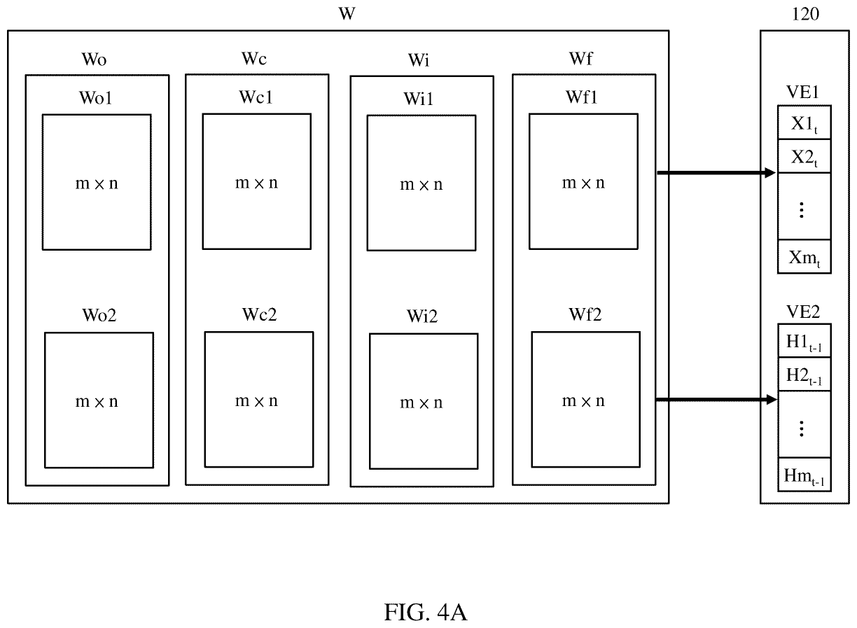

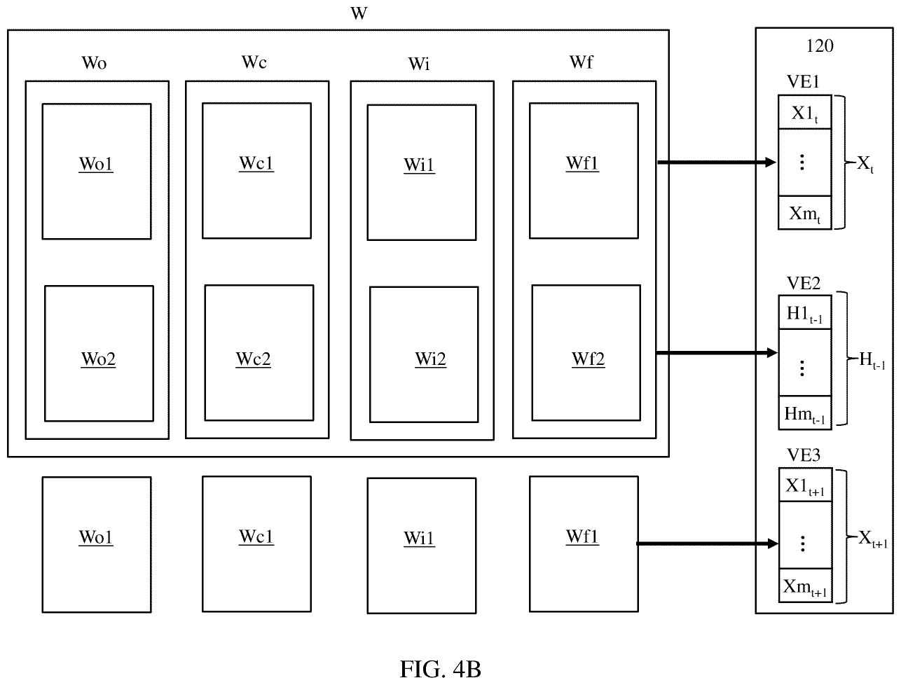

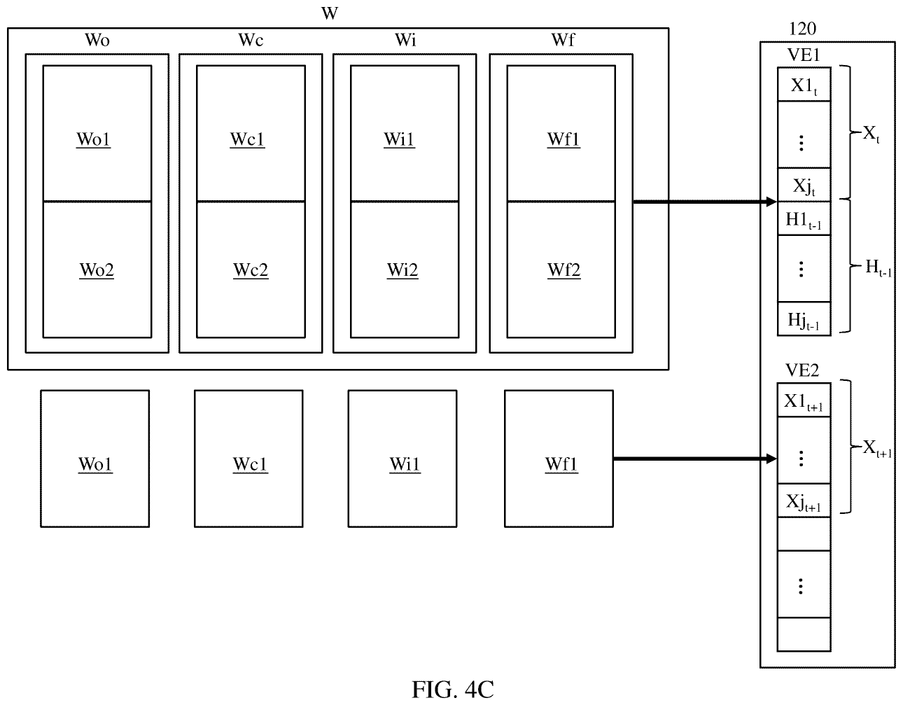

Reference is now made to FIGS. 1-2, 3A-3B and 4A. FIG. 4A is a schematic diagram of an example of dataflow to the MAC circuit 120 corresponding to the dataflow shown in FIG. 3A, in accordance with some embodiments of the present disclosure.

In some embodiments, an input vector and a hidden vector are stored in different vector engine circuits, for example, VE1-VE2 of FIG. 4A; and portions of the weight matrix W corresponding to the input vector and the hidden vector are streamed to the corresponding vector engine circuits separately. For example, in the embodiment shown in FIG. 3A, an input vector and a hidden vector of a LSTM RNN are m×1 vectors. First portions Wo1, Wc1, Wi1, Wf1, corresponding to the input vector, of the matrices Wo, Wc, Wi, Wf are m×n matrices. Second portions Wo2, Wc2, Wi2, Wf2, corresponding to the hidden vector, of the matrices Wo, Wc, Wi, Wf are m×n matrices. In a LSTM RNN time step t, elements X1ₜ-Xmₜ of an input vector are stored in the m MAC units 121 of the vector engine circuit VE1. Elements H1ₜ₋₁-Hmₜ₋₁ of a hidden vector generated in a previous LSTM time step t−1 are stored in the m MAC units 121 of the vector engine circuit VE2. The vector engine circuit VE1 performs MAC operations with the input vector and the first portions Wo1, Wc1, Wi1, Wf1 of the matrices Wo, Wc, Wi, Wf streamed from the weight memory 220. to Similarly, the vector engine circuit VE2 performs MAC operations with the hidden vector and the second portions Wo2, Wc2, Wi2, Wf2 of the matrices Wo, Wc, Wi, Wf streamed from the weight memory 220.

Reference is now made to FIGS. 1-2, 3A-3B and 4A-4B. FIG. 4B is a schematic diagram of another example of dataflow to the MAC circuit 120, in accordance with some embodiments of the present disclosure.

In some embodiments of FIG. 4B, in a time step t of computations of a RNN, idling vector engine circuits VE (e.g., the vector engine circuits VE that are not used for the RNN computations of the current time step) are used to perform MAC operations of input vectors of the following time step t+1.

For example, as shown in FIG. 4B, in a time step t, the vector engine circuits VE1 and VE2 are used to store the input vector Xₜ and the hidden vector Hₜ₋₁ to perform the MAC computations of the time step t. An idling vector engine circuit VE3 is used to store the input vector Xₜ₊₁ of the following time step t+1.

As shown in FIG. 4B, at the time step t, portions of the weight matrix (e.g., Wo1, Wc1, Wi1, Wf1) corresponding to the input vector Xₜ₊₁ are streamed to the vector engine circuit VE3 to perform MAC operations to the input vector Xₜ₊₁.

Reference is now made to FIGS. 1-2, 3A-3B and 4A-4C. FIG. 4C is a schematic diagram of another example of dataflow to the MAC circuit 120, in accordance with some embodiments of the present disclosure.

In some embodiments, one vector engine circuit VE is used to store an input vector and a hidden vector. For example, as shown in FIG. 4C, at a time step t, a vector engine circuit VE1 stores the input vector Xₜ and the hidden vector Hₜ₋₁ to perform the MAC operation of the time step t.

For illustration, in the embodiment shown in FIG. 4C, an input vector and a hidden vector of a LSTM RNN are j×1 vectors. First portions Wo1, Wc1, Wi1, Wf1, corresponding to the input vector, of the matrices Wo, Wc, Wi, Wf are j×k matrices. Second portions Wo2, Wc2, Wi2, Wf2, corresponding to the hidden vector, of the matrices Wo, Wc, Wi, Wf are j×k matrices.

At the time step t, the input vector Xₜ with elements X1ₜ-Xjₜ is stored in the vector engine circuit VE1, and the hidden vector Hₜ₋₁ generated in a previous time step t−1 with elements H1ₜ₋₁-Hjₜ₋₁ is also stored in the vector engine circuit VE1. The first and second portions Wo1, Wc1, Wi1, Wf1, Wo2, Wc2, Wi2 and Wf2 are streamed to the vector engine circuit VE1 to perform MAC operations with the input vector Xₜ and hidden vector Hₜ₋₁ (i.e., RNN computations of the current time step t).

In the time step t, the idling vector engine circuit VE2 is used to perform MAC operations of an input vector Xₜ₊₁ of the following time step t+1. The vector engine circuit VE2 stores the input vector Xₜ₊₁ with elements X1ₜ₊₁-Xjₜ₊₁. The first portions Wo1, Wc1, Wi1, Wf1, corresponding to input vector, of the matrices Wo, Wc, Wi, Wf are broadcasted to the vector engine circuit VE2 for performing MAC operations of the time step t+1.

The configurations of FIGS. 1-2, 3A-3B and 4A-4C are given for illustrative purposes. Various implements are within the contemplated scope of the present disclosure. For example, in some embodiments, the dimensions of the input vector and the hidden vector are different. In some embodiments, the size (number of MAC units 121) of the vector engine circuit VE may be smaller or greater than the dimensions of the input vector and the hidden vector. In some embodiments, the number of the vector engine circuits VE in the MAC circuit 120 may be fewer or more than two. In some embodiments, the RNN of the circuit 100 may be a vanilla RNN or a gated recurrent unit (GRU) RNN, etc.

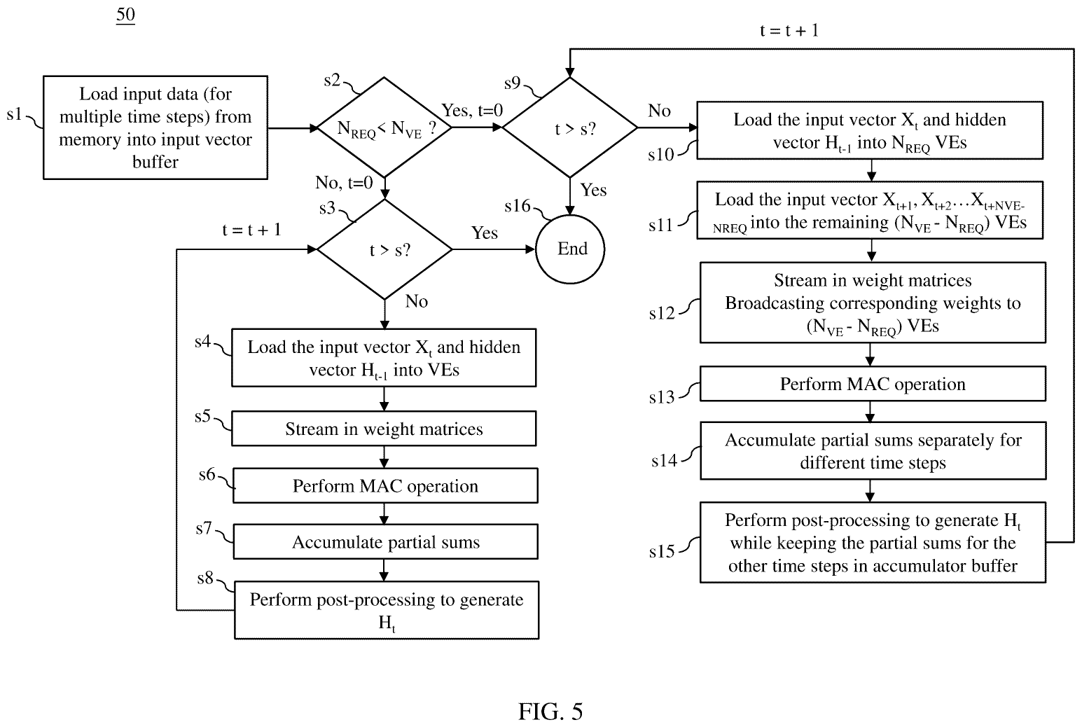

In some embodiments, after the MAC circuit 120 performing the MAC operations, the adder tree 130, the accumulator buffer 140 and the post processing circuit 150 of FIG. 1 generate a hidden vector according to the MAC operations. Then the hidden vector buffer 160 stores the generated hidden vector. In some embodiments, the generated hidden vector is transmitted to the MAC circuit 120 to performing MAC operations of the following time step. Further details about generating hidden vectors of a RNN through the memory device 10 would be described in the following paragraphs with reference to FIG. 5.

Reference is now made to FIG. 5. FIG. 5 is a flowchart diagram of a method 50 for operating the memory device 10 as shown in FIG. 1, in accordance with some embodiments of the present disclosure. It is understood that additional steps can be provided before, during, and after the steps shown by FIG. 5, and some of the steps described below can be replaced or eliminated, for additional embodiments of the method. The order of the steps may be interchangeable. Throughout the various views and illustrative embodiments, like reference numbers are used to designate like elements. The method 50 includes steps s1-s16 that are described below with reference to the memory device 10, corresponding to FIGS. 1-2, 3A-3B and 4A-4C.

In some embodiments, the controller 300 of FIG. 1 generates the signals ADDR_IN and ADDR_W to the memory 200. According to some embodiments in which the input memory 210 is a group of memory cells storing input data of a RNN, the signal ADDR_IN indicates the memory addresses of the input memory 210. Similarly, according to some embodiments in which the weight memory 220 is a group of memory cells storing weights of the RNN, the signal ADDR_W indicates the memory addresses of the weight memory 210.

According to some embodiments in which the input memory 210 is a buffer for the input data, the signal ADDR_IN indicates the memory addresses of memory cells of the memory 200 that store the input data to be loaded into the input memory 210. Similarly, according to some embodiments in which the weight memory 220 is a buffer for the weights, the signal ADDR_W indicates the memory addresses of memory cells of the memory 200 that store the weights to be loaded into the weight memory 220.

In the step s1, the input data are loaded from the input memory 210 into the input vector buffer 110. In some embodiments, the input data loaded into the input vector buffer 110 includes multiple input vectors for different time steps of the RNN.

In the step s2, the circuit 100 or the controller 300 compares a number N_{VE} with a number N_{REQ}. The number N_{VE} is a total number of vector engine circuits VE in the MAC circuit 120. The number N_{REQ} indicates the number of vector engine circuits VE required to perform MAC operations of a time step of the RNN. An equation of the number N_{REQ} is as follows: N_{REQ}=ceil((D_{IN}+D_{H})/N_{MAC}). Ceil indicates a ceiling function. D_{IN} indicates the dimension (length) of the input vector. D_{H} indicates the dimension of the hidden vector. The number N_{MAC} is a number of MAC units per vector engine circuit VE.

In some embodiments, after the step s2 is performed, a number of the time step t of the RNN is set as “0”.

When the number N_{REQ} is not smaller than the number N_{VE} according to the comparison in the step s2, the step s3 is performed. In the step s3, the circuit 100 or the controller 300 compares the number of the time step t with a number s, in which the number s indicates a total number of time steps of the RNN.

When the number of the time step t is not greater than the number s according to the comparison in the step s3, the step s4 is performed.

In the step s4, the circuit 100 loads an input vector Xₜ and a hidden vector Hₜ₋₁ into the vector engine circuits VE, in which the input vector Xₜ is an input vector of the time step t from the input vector buffer 110, and the hidden vector Hₜ is a hidden vector generated at a previous time step t−1 from the hidden vector buffer 160.

In some embodiments as shown in FIG. 1, the controller 300 generates the signal HV_SEL to the hidden vector buffer 160 to determine whether the hidden vector buffer 160 generates a random vector (e.g., vector with random numbers as elements) as a hidden vector outputted to the MUX 170. For example, in some embodiments, the hidden vector buffer 160 outputs a random vector as the hidden vector to the MUX 170 in response to the signal HV_SEL having a first value (e.g., logic one). In the other hand, the hidden vector buffer 160 outputs a hidden vector of the previous time step t−1 as the hidden vector to the MUX 170 in response to the signal HV_SEL having a second value (e.g., logic zero). In some embodiments, when the number of the time step t is 0 (initial time step), the hidden vector buffer 160 outputs a random vector to the MUX 170. When the number of the time step t is greater than 0, the hidden vector buffer 160 outputs the hidden vector of the previous time step t−1 to the MUX 170.

In some embodiments, the MAC circuit 120 store data outputted from the MUX 170 into the vector engine circuit VE. In some embodiments, the controller 300 generates the signal XH_SEL to control the MUX 170. The MUX 170 selects an input vector from the input vector buffer 110 or a hidden vector from the hidden vector buffer 160 to store in a vector engine circuit VE according to the signal XH_SEL. For example, the MUX 170 selects the input vector to store in response to the signal XH_SEL having a first value (e.g., logic one) and selects the hidden vector to store in response to the signal XH_SEL having a second value (e.g., logic zero).

In the step s5, the weights of the RNN are streamed to the MAC circuit 120. For example, the weights are streamed to the vector engine circuits VE for MAC operations as described in the embodiments corresponding to FIG. 3A.

In the step s6, the vector engine circuits VE in the MAC circuit 120 perform MAC operations of the time step t. According to some embodiments, the MAC operations are performed to generate dot product results of the weights with the input vectors and the hidden vectors in the vector engine circuits VE, as described in the embodiments corresponding to FIG. 3A.

In some embodiments, as shown in FIG. 1, each vector engine circuit VE outputs a result (partial sum) of the MAC operation to an adder 131 of the adder tree 130. In the step s7, the adders 131 of the adder tree 130 accumulate the partial sums to generate the dot product results of the weights and the input/hidden vectors.

In some embodiments, MAC operations of the input vector Xₜ and the hidden vector Hₜ₋₁ require multiple vector engine circuits VE to perform. In such embodiments, multiple MAC operation results from multiple vector engine circuits VE corresponding to the input vector Xₜ and the hidden vector Hₜ₋₁ are outputted to multiple adders 131 for accumulation to generate the dot product result of a streamed vector of the weight matrix W with the input vector Xₜ and the hidden vector Hₜ₋₁. As described in the embodiments corresponding to FIGS. 1 and 3A, output of each adder 131 is coupled to the accumulator buffer 140 through a bypass path BP.

In some embodiments, the controller 300 generates the signal PS_SEL to the accumulator buffer 140 for selecting bypass paths BP that output the dot product results. The accumulator buffer 140 selects the bypass path BP and stores the result on the selected bypass path BP according to the signal PS_SEL. Specifically, the accumulator buffer 140 selects the bypass path BP that transmits the dot product result of the input vector Xₜ, the hidden vector Hₜ₋₁ and a streamed vector of the weights matrix W according to the signal PS_SEL. In some embodiments, the accumulator buffer 140 connects to the selected bypass paths BP and disconnects from the unselected bypass paths BP.

In the step s8, the post processing circuit 150 performs post processing to the results stored in the accumulator buffer 140 to generate a hidden vector Hₜ of the time step t. According to some embodiments in which the RNN is a LSTM RNN, the accumulator buffer 140 stores the dot product results of Wo·[hₜ₋₁, xₜ], Wc·[hₜ₋₁, xₜ], Wi·[hₜ₋₁, xₜ], and Wf·[hₜ₋₁, xₜ] as described in the previous paragraphs. The post processing circuit 150 performs post processing operations like sigmoid function, bias addition, etc. to generate the hidden vector Hₜ. In some embodiments, the results stored in the accumulator buffer 140 corresponding to the time step t are removed in the step s8.

After the step s8 is performed, the number of the time step t is increased by 1. In other words, the time step t is updated to a next time step t+1, and the step s3 repeats. When the number of the time step t is greater than the number s according to the step s3, the step s16 is performed to end the process of the method 50.

As shown in FIG. 5, when the number N_{REQ} is smaller than the number N_{VE} according to the comparison in the step s2, the step s9 is performed. In the step s9, similar to the step s3, the circuit 100 or the controller 300 compares the number of the time step t with a number s.

When the number of the time step t is not greater than the number s according to the comparison in the step s9, the step s10 is performed. In the step s10, the circuit 100 loads the input vector Xₜ and the hidden vector Hₜ₋₁ into a first group of vector engine circuits VE, which has the number N_{REQ} of vector engine circuits VE. In some embodiments, when the MAC operations of the input vector Xₜ are already performed (stored in the accumulator buffer 140), only the hidden vector Hₜ₋₁ is loaded in the step s10.

In the step s11, the circuit 100 loads a number (N_{VE}-N_{REQ}) of input vectors Xₜ₊₁, Xₜ₊₂ . . . X_{t+NVE-NREQ} of the following number (N_{VE}-N_{REQ}) time steps into a second group of vector engine circuits VE, in which the second group are the remaining number (N_{VE}-N_{REQ}) vector engine circuits VE in the MAC circuit 120.

In the step s12, the weights are streamed into the MAC circuit 120. For example, the weights are streamed to the vector engine circuits VE for MAC operations as described in the embodiments corresponding to FIGS. 4B-4C. The corresponding portions of the weight matrix W (e.g., Wo1, Wc1, Wi1, Wf1) are broadcasted to the remaining number (N_{VE}-N_{REQ}) vector engine circuits VE to perform MAC operations of inputs of the following number (N_{VE}-N_{REQ}) time steps.

In the step s13, the vector engine circuits VE in the MAC circuit 120 perform MAC operations of the input and hidden vectors of the time step t and perform MAC operations of the input vectors of the following number (N_{VE}-N_{REQ}) time steps.

In the step s14, the adder tree 130 accumulates the MAC operation results from the MAC circuit 120. The partial sums corresponding to different time steps are accumulated separately. Specifically, the accumulator buffer 140 selects bypass paths corresponding to a partial sum of the input vector Xₜ and the hidden vector Hₜ₋₁, and partial sums of input vectors Xₜ₊₁, Xₜ₊₂ . . . X_{t+NVE-NREQ} separately.

In the step s15, similar to the step s8, the post processing circuit 150 performs post processing to the dot product result (partial sum) corresponding to the input vector Xₜ and the hidden vector Hₜ₋₁ stored in the accumulator buffer 140 to generate a hidden vector Hₜ of the time step t. In some embodiments, the results stored in the accumulator buffer 140 corresponding to the time step t are removed in the step s15. In contrast, the results corresponding to the following time steps (e.g., partial sums of input vectors Xₜ₊₁, Xₜ₊₂ . . . X_{t+NVE-NREQ}) stored in the accumulator buffer 140 are kept stored.

After the step s15 is performed, the number of the time step t is increased by 1, and the step s9 repeats. When the number of the time step t is greater than the number s according to the step s9, the step s16 is performed to end the process of the method 50.

As described above, the present disclosure provides a memory device and a method to operate the memory device. The memory device and the method implement NMC of RNN operations. The proposed vector engine circuits of the memory device with specific dataflow reduce weight reloading and provide about four times less input memory accesses compared to some approaches. In addition, the proposed method leverages the idling vector engine circuits to achieve parallel processing for different time steps.

In some embodiments, a memory device is provided. The memory device comprises a multiply-and-accumulate (MAC) circuit and a post processing circuit. The multiply-and-accumulate (MAC) circuit comprises vector engine circuits that store a first input vector of a current time step of a recurrent neural network (RNN) and a first hidden vector of a previous time step of the RNN. The vector engine circuits perform MAC operations of the first input vector, the first hidden vector and a weight matrix. The post processing circuit generates a second hidden vector of the current time step of the RNN according to results of the MAC operations.

In some embodiments, the memory device of claim further comprises a multiplexer. The multiplexer selects one of the first input vector and the first hidden vector to store in one of the vector engine circuits.

In some embodiments, the memory device further comprises a buffer that is coupled between the post processing circuit and the multiplexer. The buffer stores the second hidden vector.

In some embodiments, the buffer generates a random vector as an initial hidden state to the multiplexer in response to a control signal from a controller.

In some embodiments, the memory device further comprises an adder tree comprising adders. The adders add the results of the MAC operations to generate a dot product result of the first input vector, the first hidden vector and a weight vector of the weight matrix.

In some embodiments, the memory device further comprises a controller and a buffer. The controller generates a control signal. The buffer connects to a bypass path of a first adder of the adders that transmits the dot product result in response to the control signal.

In some embodiments, the weight matrix is a concatenation of sub-matrices. The vector engine circuits perform the MAC operations of the first input vector with the sub-matrices sequentially.

In some embodiments, each of the vector engine circuits comprises MAC units. Each of the MAC units comprises a memory cell and a computing circuit. The memory cell stores a first element. The first element is of an input vector or a hidden vector from the multiplexer. The computing circuit performs a multiply operation to the first element and a second element of the weight matrix streamed to the computing circuit.

In some embodiments, the first input vector and the first hidden vector are stored in a first vector engine circuit of the vector engine circuits to perform the MAC operations.

In some embodiments, a memory device comprises a multiply-and-accumulate (MAC) circuits, a first buffer, a second buffer and a multiplexer. The multiply-and-accumulate circuits comprises vector engine circuits. The first buffer stores input vectors corresponding to different time steps of a recurrent neural network (RNN). The second buffer stores hidden vectors corresponding to the different time steps. The multiplexer selects a first input vector of the input vectors to store in a first vector engine circuit of the vector engine circuits and to select a first hidden vector of the hidden vectors to store in a second vector engine circuit of the vector engine circuits in a first time step of the RNN. The vector engine circuits perform multiply-and-accumulate (MAC) operations of the first input vector, the first hidden vector and a weight matrix to generate a second hidden vector.

In some embodiments, the memory device further comprises an adder tree that add results of the MAC operations to generate a first dot product result of the first input vector, the first hidden vector and a weight vector of the weight matrix.

In some embodiments, a third vector engine circuit of the vector engine circuits stores a second input vector of the input vectors.

In some embodiments, the memory device further comprises a third buffer coupled to adders of the adder tree through bypass paths. The third buffer stores the first dot product result and a second dot product result corresponding to the second input vector from the bypass paths.

In some embodiments, the second buffer generates a random vector to the multiplexer in an initial time step of the RNN.

In some embodiments, the first vector engine circuit comprises MAC units that are coupled in series and perform an element-wise multiply operation to the first input vector and a weight vector of the weight matrix. The MAC units sum elements of the result of the element-wise multiply operation.

In some embodiments, a method for operating memory device is provided. The method comprises: loading a first input vector, from input vectors, of a current time step of a recurrent neural network (RNN) and a first hidden vector of a previous time step of the RNN into at least one first vector engine circuit of vector engine circuits for storing; determining, according to a length of each of the input vectors and a total number of the vector engine circuits, whether to load a second input vector of a following time step of the RNN to at least one second vector engine circuit; when the second input vector are loaded in the at least one second vector engine circuit, streaming a vector of a weight matrix of the RNN to the at least one first vector engine circuit and the at least one second vector engine circuit to generate a multiply-and-accumulate (MAC) operation result; and performing a post processing operation according to the MAC operation result to generate a second hidden vector of the following time step.

In some embodiments, the determining further comprises determining a required number of the vector engine circuits for the current time step according to the length and a number of MAC units in each of the vector engine circuits to load the second input vector to the at least one second vector engine circuit according to the total number of the plurality of vector engine circuits greater than the required number.

In some embodiments, the method further comprises storing hidden vectors corresponding to different time steps in a buffer; and outputting the hidden vectors stored in the buffer as an output of the RNN.

In some embodiments, the method further comprises outputting a random vector as an initial hidden vector through the buffer.

In some embodiments, the method further comprises concatenating gate matrices of the RNN to generate the weight matrix; and streaming columns of vectors of the weight matrix to the at least one second vector engine circuit sequentially.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A memory device, comprising:
a multiply-and-accumulate (MAC) circuit, comprising:
a plurality of vector engine circuits configured to store a first input vector of a current time step of a recurrent neural network (RNN) and a first hidden vector of a previous time step of the RNN,
wherein the plurality of vector engine circuits are further configured to perform MAC operations of the first input vector, the first hidden vector and a weight matrix; and
a post processing circuit configured to generate a second hidden vector of the current time step of the RNN according to results of the MAC operations.

2. The memory device of claim 1, further comprising:
a multiplexer configured to select one of the first input vector and the first hidden vector to store in one of the plurality of vector engine circuits.

3. The memory device of claim 2, wherein each of the plurality of vector engine circuits comprises:
a plurality of MAC units, wherein each of the plurality of MAC units comprises:
a memory cell configured to store a first element, wherein the first element is of an input vector or a hidden vector from the multiplexer; and
a computing circuit configured to perform a multiply operation to the first element and a second element of the weight matrix streamed to the computing circuit.

4. The memory device of claim 2, further comprising:
a buffer that is coupled between the post processing circuit and the multiplexer and is configured to store the second hidden vector.

5. The memory device of claim 4, wherein the buffer is further configured to generate a random vector as an initial hidden state to the multiplexer in response to a control signal from a controller.

6. The memory device of claim 1, further comprising:
an adder tree, comprising:
a plurality of adders configured to add the results of the MAC operations to generate a dot product result of the first input vector, the first hidden vector and a weight vector of the weight matrix.

7. The memory device of claim 6, further comprising:
a controller configured to generate a control signal; and
a buffer configured to connect to a bypass path of a first adder of the plurality of adders that transmits the dot product result in response to the control signal.

8. The memory device of claim 6, wherein the weight matrix is a concatenation of a plurality of sub-matrices,
wherein the plurality of vector engine circuits perform the MAC operations of the first input vector with the plurality of sub-matrices sequentially.

9. The memory device of claim 1, wherein the first input vector and the first hidden vector are stored in a first vector engine circuit of the plurality of vector engine circuits to perform the MAC operations.

10. A memory device, comprising:
a multiply-and-accumulate (MAC) circuits, comprising:
a plurality of vector engine circuits;
a first buffer configured to store a plurality of input vectors corresponding to different time steps of a recurrent neural network (RNN);
a second buffer configured to store a plurality of hidden vectors corresponding to the different time steps; and
a multiplexer configured to select a first input vector of the plurality of input vectors to store in a first vector engine circuit of the plurality of vector engine circuits and to select a first hidden vector of the plurality of hidden vectors to store in a second vector engine circuit of the plurality of vector engine circuits in a first time step of the RNN,
wherein the plurality of vector engine circuits are configured to perform multiply-and-accumulate (MAC) operations of the first input vector, the first hidden vector and a weight matrix to generate a second hidden vector.

11. The memory device of claim 10, further comprising:
an adder tree configured to add results of the MAC operations to generate a first dot product result of the first input vector, the first hidden vector and a weight vector of the weight matrix.

12. The memory device of claim 11, wherein a third vector engine circuit of the plurality of vector engine circuits is configured to store a second input vector of the plurality of input vectors.

13. The memory device of claim 12, further comprising:
a third buffer coupled to a plurality of adders of the adder tree through a plurality of bypass paths,
wherein the third buffer is configured to store the first dot product result and a second dot product result corresponding to the second input vector from the plurality of bypass paths.

14. The memory device of claim 10, wherein the second buffer is further configured to generate a random vector to the multiplexer in an initial time step of the RNN.

15. The memory device of claim 10, wherein the first vector engine circuit comprises:
a plurality of MAC units that are coupled in series and configured to perform an element-wise multiply operation to the first input vector and a weight vector of the weight matrix,
wherein the plurality of MAC units are further configured to sum elements of a result of the element-wise multiply operation.

16. A method for operating memory device, comprising:
loading a first input vector, from a plurality of input vectors, of a current time step of a recurrent neural network (RNN) and a first hidden vector of a previous time step of the RNN into at least one first vector engine circuit of a plurality of vector engine circuits for storing;
determining, according to a length of each of the plurality of input vectors and a total number of the plurality of vector engine circuits, whether to load a second input vector of a following time step of the RNN to at least one second vector engine circuit;
when the second input vector are loaded in the at least one second vector engine circuit, streaming a vector of a weight matrix of the RNN to the at least one first vector engine circuit and the at least one second vector engine circuit to generate a multiply-and-accumulate (MAC) operation result; and
performing a post processing operation according to the MAC operation result to generate a second hidden vector of the following time step.

17. The method of claim 16, wherein the determining further comprising:
determining a required number of the plurality of vector engine circuits for the current time step according to the length and a number of MAC units in each of the plurality of vector engine circuits to load the second input vector to the at least one second vector engine circuit according to the total number of the plurality of vector engine circuits greater than the required number.

18. The method of claim 16, further comprising:
storing a plurality of hidden vectors corresponding to different time steps in a buffer; and
outputting the plurality of hidden vectors stored in the buffer as an output of the RNN.

19. The method of claim 18, further comprising:
outputting a random vector as an initial hidden vector through the buffer.

20. The method of claim 16, wherein the streaming further comprising:
concatenating a plurality of gate matrices of the RNN to generate the weight matrix; and
streaming columns of vectors of the weight matrix to the at least one second vector engine circuit sequentially.
